(19) United States
(12) Patent Application Publication
(10) Pub. No.: US 2025/0029582 A1
(43) Pub. Date: Jan. 23, 2025

(54) SymetrEWI

(71) Applicant: Christopher Vincent Dragotta, Newfoundland, NJ (US)

(72) Inventor: Christopher Vincent Dragotta, Newfoundland, NJ (US)

(21) Appl. No.: 18/354,105

(22) Filed: Jul. 18, 2023

(51) Int. Cl. G10H 1/055; G10H 1/34

(52) U.S. Cl. CPC G10H 1/0551; G10H 1/34; G10H 2220/201

(57) ABSTRACT

An electronic wind instrument includes capacitance touch switch key touches, a breath pressure sensor, and pinky key touches configured specifically for the purpose of transposing musical phrases into any of the 12 musical keys.

### SPECIFICATIONS

There are only two different pitches (or notes) that are performed on a saxophone or flute with either the left or right pinky. (G #and D #, respectively).

However, both of those musical pitches can be indicated or “fingered” without using the pinkies on an EWI using alternate placements of the six middle remaining fingers upon the touches (FIG. 1, 2), allowing the pinky finger of each hand to be dedicated only to the task of transposing the entire keyboard into any of the 12 musical keys, using the pinky touches (FIG. 1, 3), (FIG. 2, (9, 10, 11, 12), which are staggered in such a way as to allow clear access to all 4 touches by the pinky tip, both one at a time and in 4 distinctly different combinations of two at a time as well as all 4 simultaneously, giving a possible 9 positions for the tip of the pinky, using just 4 touch points.

This “breaking out” of the pinky fingers for the sole purpose of transposition, gives the musician the choice to use the same fingerings for a given melody or melodic fragment or sequence of musical intervals, for each of the 12 musical keys.

In this way, this use of the pinky keys develops the standard Boehme finger board* for woodwinds into a truly isomorphic interface. Isomorphic here referring the same fingerings for all 12 keys.

This in turn, allows for composition, improvisation, arranging facility that would not be possible with a conventional woodwind keyboard layout.

*Boehme Keyboard: The Boehm system is a system of keywork for the flute, created by inventor and flautist Theobald Boehm between 1831 and 1

### BRIEF DESCRIPTION OF THE DRAWINGS

FIG. 1

This shows the overhead or top down view of the instrument as positioned on top of the players' lap.

FIG. 2

This shows the left side view.

FIG. 3

Shows the first of two non-preferred embodiments.

FIG. 4

Shows the second of two non-preferred embodiments.

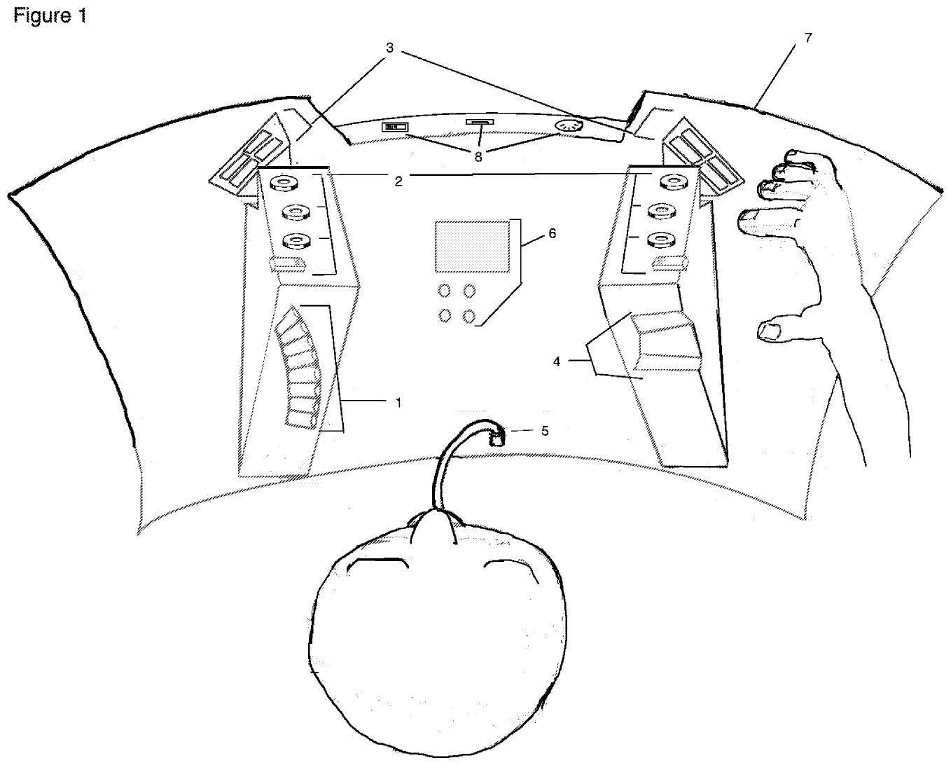

### DETAILED DESCRIPTION

[FIG. 1]. The player uses left thumb capacitance touch rollers [FIG. 1, 1] to select the octave of the note fingered by the six middle fingers as selected by the player using the six circular fingertip touches and two side keys [FIG. 1, 2].

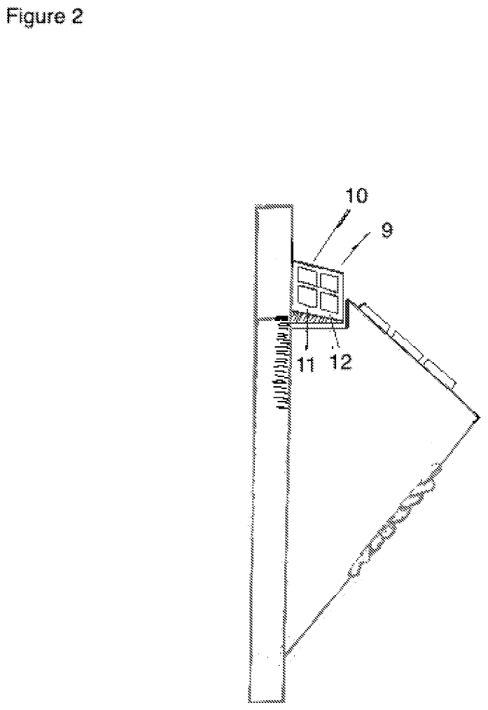

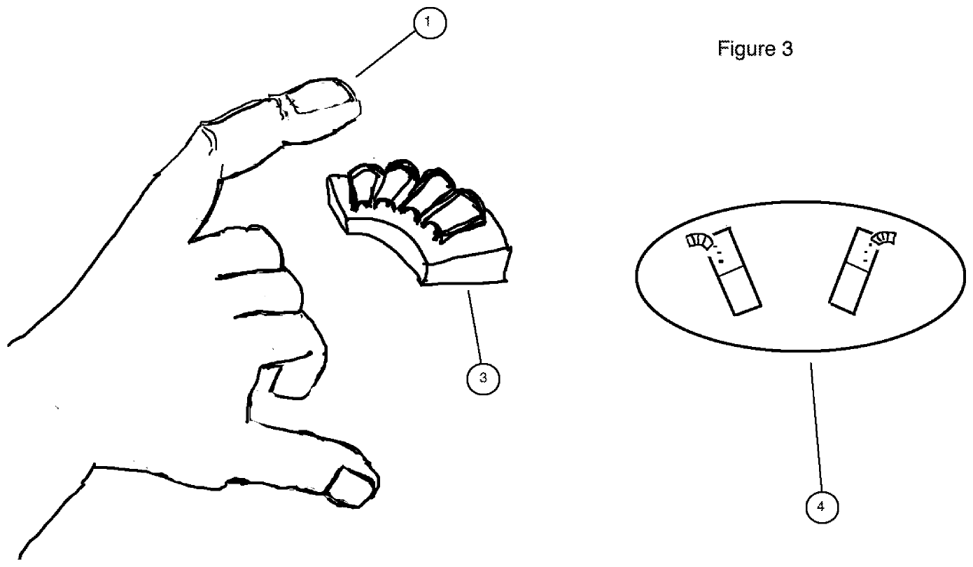

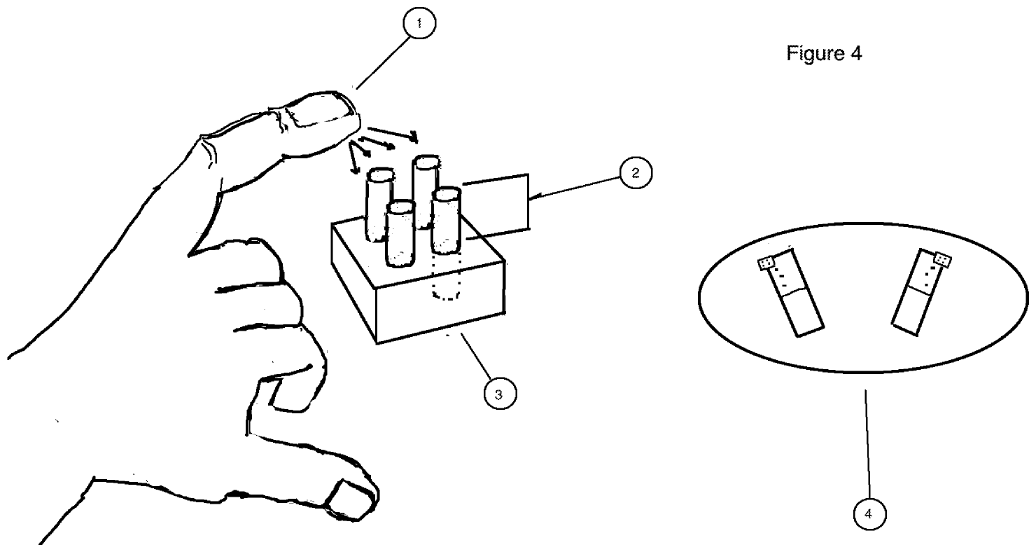

The transposition of the currently fingered note is selected using the pinky fingers of either hand, using the four bar shaped touches staggered on two planes, one high and one low. [FIG. 1,3], [FIG. 2, (9, 10, 11, 12.)]

[FIG. 3]. This is the first of two non-preferred embodiments. Same as above, but in curved array of 4 conical rollers [FIG. 3 (3)] can be accessed by the tip of the little finger, or pinky, of each hand [FIG. 3 (1)].

[FIG. 3]. The overhead view of the two arrays of four conical pinky rollers relative to the triangular shaped hand grabs is pictured in [FIG. 3 (4)].

[FIG. 4]. The second of two non-preferred embodiments, which is the same as above, but is instead a block of 4 capacitance touch pins [FIG. 4 (3)], which can be accessed by the tip of the little finger, or pinky, of each hand [FIG. 4 (1)].

The height of each pin being adjustable to the needs of the player [FIG. 4 (2)].

The overhead view of the two blocks of four pins, relative to the triangular shaped hand grabs is pictured [FIG. 4 (4)].

### BACKGROUND

The capacitance touch switches used on the EWI to emulate the pinky touches of an actual acoustic instrument are here repurposed and extended in function (FIG. 1, (3), FIG. 2, (9, 10, 11, 12).

(FIG. 1 is overhead view of player who performs with instrument flat surface (7), placed on lap and who blows air into tube (5), which starts musical note by affecting a pressure sensor. FIG. 1, (6) is the LCD screen and navigation buttons for configuring the instrument. FIG. 1, (8) are power switch, USB port and MIDI Data ports.)

(FIG. 2 is the side view of the left hand grab, showing the arc of conical thumb rollers, and the side view of the upper and lower plane of the proximal and distal pinky touches (9, 10, 11, 12).)

On an acoustic wind instrument, these pinky keys affect only one musical note each. However, the pinky keys on an EWI can affect any note that is fingered with the remaining 6 fingers and thumbs, which are used to operate finger touches (FIG. 1, 1, 2)

### FIELD

The SymetrEWI or alternatively, The DrEWI, is a modification of the EWI (Electronic Wind Instrument), the generic term for an electronic wind instrument that uses breath pressure and the fingering system as found on saxophones and flutes, earlier referred to as the Boehm Fingering system*.

1. A device comprised of a flat surface, upon which are two triangular shaped hand-grabs, upon each of these hand grabs, capacitance touch switches are placed in a configuration to emulate a Boehme flute key board arrangement of capacitance touch switches.

2. A device according to claim 1, upon which both left and right hand-grabs each have 4 pinky touches all on the same plane of a triangular shaped block that can be rotated to adjust to the liking of each individual player, such that the pinky can touch one, two or four of these touches simultaneously with minimal effect on the position of the rest of the hand and other fingers.

3. The pinky touches of the device according to claim 2, are arranged in a flat plane of a triangular shaped block, which can from this point forward in this document be described as the proximal and distal pinky touches of the top and bottom plane.

4. If proximal touch of the top plane is contacted by the tip of either the left or right pinky, then the “Currently Played Note” (CPN) will be transposed one step higher.

5. If proximal and distal pinky touches of the top plane are contacted by the tip of either pinky simultaneously, the CPN will be transposed two steps higher.

6. If only the distal pinky touch of the top plane of either one of the pinky touches is contacted by the tip of either pinky, the CPN will be transposed three steps higher.

7. If the distal pinky touches of both the top and bottom plane are touched simultaneously by the tip of the pinky, the CPN will be transposed four steps higher.

8. If the distal pinky touches of only the bottom plane are touched by the tip of the pinky, the CPN will be transposed five steps higher.

9. If the distal and proximal pinky touches of only the bottom plane are touched by the tip of the pinky, the CPN will be transposed six steps higher.

10. If the proximal pinky touch of only the bottom plane is touched by the tip of the pinky, the CPN will be transposed seven steps higher.

11. If the proximal pinky touches of both the top and bottom planes are touched by the tip of the pinky, the CPN will be transposed eight steps higher.

12. If the proximal and distal pinky touches of both the top and bottom planes are touched by the tip of the pinky, the CPN will be transposed nine steps higher.

13. When the pinkies are used upon these touches individually or in combination, all 12 musical keys (and more) can be indicated or registered by the performer.
